(19) United States
(12) Patent Application Publication
(10) Pub. No.: US 2021/0144630 A1
(43) Pub. Date: May 13, 2021

(54) BASE STATION AND DATA TRANSMISSION METHOD THEREOF FOR MOBILE COMMUNICATION SYSTEM

(71) Applicant: Institute For Information Industry, Taipei (TW)

(72) Inventor: Tzu-Ya WANG, Taipei (TW)

(21) Appl. No.: 16/705,208

(22) Filed: Dec. 5, 2019

(30) Foreign Application Priority Data
Nov. 13, 2019 (TW) 108141212

(51) Int. Cl. H04W 48/16; H04W 8/08; H04W 80/10; H04W 76/11; H04W 76/15; G06F 9/455

(52) U.S. Cl. CPC H04W 48/16; H04W 8/08; H04W 80/10; G06F 2009/45595; H04W 76/15; G06F 9/45558; H04W 76/11

(57) ABSTRACT

A base station (BS) and data transmission method thereof for mobile communication system thereof are provided. The BS transmits an ultra-reliable transmission parameter of a user equipment (UE) to a core network to make a user plane function (UPF) of the core network establish a first protocol data unit (PDU) session with the UE via the BS. The BS selects a secondary BS and transmits UE information to the secondary BS over a communication interface. The BS transmits a BS selection message to the UE to make the UE connect to the secondary BS. The BS transmits the BS selection message to the core network to make another UPF of the core network establish a second PDU session with the UE via the secondary BS.

### PRIORITY

This application claims priority to Taiwan Patent Application No. 108141212 filed on Nov. 13, 2019, which is hereby incorporated by reference in its entirety.

### FIELD

The present invention relates to a base station (BS) and a data transmission method thereof for a mobile communication system. To be more specific, the BS of the present invention selects a secondary BS based on an ultra-reliable transmission requirement of a user equipment (UE), and transmits UE information to the secondary BS over a communication interface to make a core network establish a protocol data unit (PDU) session with the UE via the secondary BS after the UE connects to the secondary BS.

### BACKGROUND

With the rapid development of wireless communication technologies, wireless communication has found wide application in people's life, and people's demand for wireless communication is increasing. The next generation of mobile communication system (which is generally referred to as the 5G mobile communication system currently) has proposed new service types, e.g., Ultra-reliable and Low Latency Communication (URLLC), Enhanced Mobile Broadband (eMBB) communication, and Massive Machine Type Communication (mMTC).

According to the current planning of the 5G mobile communication system, a user equipment (UE) with ultra-reliable transmission requirement usually establishes dual connectivity with base stations (BS), and establishes two protocol data unit (PDU) sessions with the core network via the two connected BS so that the UE can transmit two sets of identical data to the core network to satisfy its ultra-reliable transmission requirement.

However, during establishing dual connectivity, after the UE connects to the master BS, the core network selects two user plane functions (UPFs) and establishes two PDU sessions with the master BS. The core network will release the transition PDU session which is established earlier until the UE connects to the secondary BS. It is a waste of network resources since there exists three PDU session between the UE and the core network in a time period.

In addition, during establishing aforementioned dual connectivity, after the master BS selects the secondary BS, the master BS needs to transmit transmission data and transmission parameters, with respect to the UE, to the core network via the backhaul, and the core network transmits the transmission data and the transmission parameters, with respect to the UE, to the secondary BS. It not only wastes network resources but also increases the time that the UE establishes dual connectivity and data transmission latency.

Accordingly, an urgent need exists in the art to provide a data transmission mechanism to reduce the number of established PDU sessions between the core network and the UE during establishing dual connectivity and further reduce data transmission latency to avoid waste of network resources.

### SUMMARY

Provided is a data transmission mechanism which makes a base station (BS) select a secondary BS based on an ultra-reliable transmission parameter of a user equipment (UE) and provides the UE and a core network with information about the secondary BS so that the core network will select a session management function (SMF) and a user plane function (UPF) for establishing a protocol data unit (PDU) session with the UE via the secondary BS when the UE is connecting to the BS.

In addition, the BS can transmit transmission information and transmission parameter about the UE to the secondary BS over a communication interface, so after the UE connects to the secondary BS, the core network will establish PDU session with the UE directly via the secondary BS. In this way, the present invention can reduce the number of established PDU sessions when the core network is establishing dual connectivity with the UE, avoid wasting resources, and shorten latency of establishing dual connectivity.

The disclosure includes a base station (BS) for a mobile communication system. The mobile communication system can comprise the BS, a core network and a plurality of neighbor BSs. The core network has an access and mobility management function (AMF), a plurality of session management functions (SMFs) and a plurality of user plane functions (UPFs). The BS comprises a transceiver, a connection port, and a processor. The connection port is configured to connect to the core network. The processor is electrically connected to the transceiver and the connection port, and is configured to execute the following operations: receiving a registration request message from a user equipment (UE) via the transceiver, the registration request message comprising an ultra-reliable transmission parameter and a neighbor BS parameter; transmitting a transmission parameter message comprising the ultra-reliable transmission parameter to the AMF via the connection port to make the AMF select a first SMF from the SMFs based on the ultra-reliable transmission parameter, and to further make the first SMF select a first UPF from the UPFs for establishing a first protocol data unit (PDU) session with the UE via the BS; selecting a secondary BS from the neighbor BSs based on the ultra-reliable transmission parameter, and transmitting UE information to the secondary BS over a communication interface via the connection port; transmitting a BS selection message to the UE via the transceiver to make the UE establish a connection with the secondary BS according to the BS selection message; and transmitting the BS selection message to the AMF via the connection port to make the AMF select a second SMF from the SMFs according to the BS selection message, and to further make the second SMF select a second UPF from the UPFs for establishing a second PDU session with the UE via the secondary BS.

The disclosure also includes a data transmission method of a base station (BS) for a mobile communication system. The mobile communication system can comprise the BS, a core network and a plurality of neighbor BSs. The core network has an access and mobility management function (AMF), a plurality of session management functions (SMFs) and a plurality of user plane functions (UPFs). The BS comprises a transceiver, a connection port and a processor. The connection port is configured to connected to the core network. The processor is electrically connected to the transceiver and the connection port. The data transmission method is executed by the processor and comprises the following steps: receiving a registration request message from a user equipment (UE), the registration request message comprising an ultra-reliable transmission parameter and a neighbor BS parameter; transmitting a transmission parameter message to the AMF, the transmission parameter message comprising the ultra-reliable transmission parameter to make the AMF select a first SMF from the SMFs based on the ultra-reliable transmission parameter, and to further make the first SMF select a first UPF from the UPFs to establish a first protocol data unit (PDU) session with the UE via the BS; selecting a secondary BS from the neighbor BSs based on the ultra-reliable transmission parameter and transmitting UE information to the secondary BS over a communication interface; transmitting a BS selection message to the UE to make the UE establish a connection with the secondary BS according to the BS selection message; and transmitting the BS selection message to the AMF to make the AMF select a second SMF from the SMFs according to the BS selection message, and to further make the second SMF select a second UPF from the UPFs to establish a second PDU session with the UE via the secondary BS.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts an implementation scenario of a mobile communication system according to the present invention.

FIG. 2 depicts an implementation scenario of connection between a base station 1 and a core network 2 according to the present invention.

FIG. 3 is a schematic view of signal transmission according to the present invention.

FIG. 4 is a schematic view of signal transmission according to the present invention.

FIG. 5 is a schematic view of the base station 1 according to the present invention.

FIG. 6 is a flow chart of a data transmission method according to the present invention.

### DETAILED DESCRIPTION

In the following description, the present invention will be explained with reference to certain example embodiments thereof. These example embodiments are not intended to limit the present invention to any particular environment, example, embodiment, applications or implementations described in these example embodiments. Therefore, description of these example embodiments is only for purpose of illustration rather than to limit the present invention.

It shall be appreciated that in the following embodiments and the attached drawings, elements unrelated to the present invention are omitted from depiction; and dimensional relationships among individual elements in the attached drawings are illustrated only for ease of understanding, but not to limit the actual scale.

The first embodiment of the present invention is as shown in FIGS. 1 to 4. FIG. 1 depicts an implementation scenario of a mobile communication system according to the present invention. FIG. 2 depicts an implementation scenario of connection between a base station (BS) 1 and a core network 2 according to the present invention. As shown in FIG. 1, the mobile communication system comprises the BS 1, the core network 2 and a plurality of neighbor BSs 3a, 3b, and 3c. The UE 4 is within the signal coverage of the BS 1 and the neighbor BSs 3a, 3b, and 3c. To simplify the description, only three neighbor BSs 3a, 3b, and 3c are depicted in FIG. 1. However, the number of neighbor BSs is not intended to limit the scope of the present invention. The mobile communication system may be the next generation of mobile communication system (broadly called the 5G mobile communication system currently) or any mobile communication systems based on the orthogonal frequency division multiple access (OFDMA) technology.

The UE 4 may be a smart phone, a tablet computer or any wireless communication device, which supports dual connectivity (DC) ability and is applicable to some ultra-reliable transmission needed scenarios, e.g., vehicle to everything (V2X), industrial internet of things (HOT), smart healthcare, etc., but not limited thereto.

The core network 2 has an access and mobility management function (AMF) 21, a plurality of session management functions (SMFs) 23 and a plurality of user plane functions (UPFs) 25.

In detail, the core network 2 of 5G mobile communication system is designed as service-based architecture (SBA). Similar services in the core network 2 are managed by a function, e.g., aforementioned AMF, SMF, and UPF, but not limited thereto. The core network 2 may be considered as a collection of these functions, and these functions may be implemented in hardware or software by one or more devices (e.g., the servers) and connected to each other via specific interfaces (e.g., the SMF and the UPF are connected via the N4 interface). In other words, each of the functions in the core network 2 is executed by an entity or a virtual machine (VM).

AMF receives all connection and session related messages from the UE 4 via the BS 1, but only in charge of access and mobility management missions, any information about session management will be transferred to SMF and then be processed by SMF. SMF provides continuous and uninterrupted user experience of a service (i.e., session continuity and service continuity), including the cases where the IP address and/or anchoring point change. The area within which protocol data unit (PDU) Session associated with the UPF can be served by radio access network (RAN) nodes via a N3; interface between the RAN and the UPF without need to add a new UPF in between or to remove/re-allocate the UPF. It shall be appreciated that each function in the core network, especially AMF, SMF, and UPF mentioned in the present invention are well-known to those of ordinary skill in the art, or may be referred to the 3GPP TS 33.512 specification, the 3GPP TS 33.515 specification, and the 3GPP TS 33.513 specification (but not limited thereto).

Please refer to FIG. 3. The BS 1 receives a registration request message 402, including an ultra-reliable transmission parameter and a neighbor BS parameter, from the UE 4. For example, the ultra-reliable transmission parameter may be 0 or 1, when the ultra-reliable transmission parameter is 0, it means that the UE 4 does not have ultra-reliable transmission requirement currently, and when the ultra-reliable transmission parameter is 1, it means that the UE 4 needs to transmit data signals with ultra-reliable way. Since the core network 2 currently provides ultra-reliable transmission for the UE 4 by allowing the UE 4 to transmit two identical data to the core network 2 through dual connectivity, the registration request message 402 includes the neighbor BS parameter when the UE 4 has ultra-reliable transmission requirement currently. The neighbor BS parameter includes a cell identity of each of the neighbor BSs 3a, 3b, and 3c.

The BS 1 (usually called a “gNB”) in the 5G mobile communication system is connected to the AMF 21 (e.g., via the N2 interface) and connected to the UPF 25 (e.g., via the N3 interface). It shall be appreciated that in the present invention, the BS 1 selects AMF and connects to the selected AMF in advance, so the BS 1 can exchange messages with connected AMF directly after the UE 4 transmits registration request message 402 to the BS 1.

After receiving the registration request message 402, the BS 1 transmits a transmission parameter message 102 including the ultra-reliable transmission parameter to the AMF 21 to make the AMF 21 select a first SMF 231 from the SMFs 23 based on the ultra-reliable transmission parameter, and to further make the first SMF 231 select a first UPF 251 from the UPFs 25 for establishing a first PDU session with the UE 4 via the BS 1.

Please refer to FIG. 4. The BS 1 selects a secondary BS 3 from the neighbor BSs 3a, 3b, and 3c based on the ultra-reliable transmission parameter, and transmits UE information to the secondary BS 3 over a communication interface (e.g., Xn interface or X2 interface). The secondary BS 3 is one of the neighbor BSs 3a, 3b, and 3c. More specifically, when the secondary BS 3 is the BS of 5G mobile communication system (i.e., gNB), the communication interface between the BS 1 and the secondary BS 3 is Xn interface, and when the secondary BS 3 is the BS of 4G mobile communication system (usually called an “eNB”), the communication interface between the BS 1 and the secondary BS 3 is X2 interface. In addition, when the neighbor BSs 3a, 3b, and 3c includes eNB, the eNB needs to support function of next generation application protocol (NGAP) interface so that the eNB is able to communicate with the core network 2 of 5G mobile communication system and be selected as the secondary BS 3.

The BS 1 may select the secondary BS 3 according to UE information which includes at least one of a current state, time information and position information of the UE 4. Besides, the BS 1 may also select the BS with lowest current load or with the least number of connected UE among the neighbor BSs 3a, 3b, and 3c as the secondary BS 3.

It shall be appreciated that the BS 1 selects the secondary BS 3 in order to make the UE 4 establish dual connectivity so that the UE 4 can transmit the same data to the core network 2 via the secondary BS 3 to satisfy ultra-reliable transmission requirement. Thus, the criteria that the BS 1 selects the secondary BS is not intended to limit the present invention, how to select the secondary BS based on the aforesaid descriptions shall be readily appreciated by those of ordinary skill in the art, and thus will not be further described herein.

The BS 1 transmits a BS selection message 104 including the cell identity of the secondary BS 3 to the UE 4 to make the UE 4 establish RAN with the BS which corresponds to the cell identity. It means that the UE 4 establishes connection with the secondary BS 3.

In addition, the BS 1 transmits the BS selection message 104 to the AMF 21 to make the AMF 21 select a second SMF 232 from the SMFs 23 according to the BS selection message 104, and to further make second SMF 232 select a second UPF 252 from the UPFs 25 for establishing a second PDU session with the UE 4 via the secondary BS 3.

In one embodiment, the BS 1 transmits the BS selection message 104 to the UE 4 and the AMF 21 at the same time, so the AMF 21 can select suitable second SMF 232 for the secondary BS 3, and the second SMF 232 can select suitable second UPF 252 while the UE 4 is connecting to the secondary BS 3. After the UE 4 connects to the secondary BS 3, the second UPF 252 is able to establish the second PDU session with the UE 4 via the secondary BS 3.

A second embodiment of the present invention is as shown in FIG. 5, which is a schematic view of the BS 1 according to the present invention. The mobile communication system comprising the BS 1, a core network and a plurality of neighbor BSs. The core network has an AMF, a plurality of SMFs and a plurality of UPFs. The BS 1 comprises a transceiver 11, a connection port 13, and a processor 15. The connection port 13 is configured to connect to the core network. The processor 15 is electrically connected to the transceiver 11 and the connection port 13. It shall be appreciated that, for simplifying the description, other components of the BS 1 such as the storage, the housing, the power supply module and other components irrelevant to the present invention are omitted from depiction in the drawings.

The processor 15 receives a registration request message from a UE via the transceiver 11. The registration request message includes an ultra-reliable transmission parameter and a neighbor BS parameter. The processor 15 transmits a transmission parameter message including the ultra-reliable transmission parameter to the AMF via the connection port 13 to make the AMF select a first SMF from the SMFs based on the ultra-reliable transmission parameter, and to further make the first SMF select a first UPF from the UPFs for establishing a first PDU session with the UE via the BS 1.

The processor 15 selects a secondary BS from the neighbor BSs based on the ultra-reliable transmission parameter, and transmits UE information to the secondary BS over a communication interface via the connection port 13. Afterwards, the processor 15 transmits a BS selection message to the UE via the transceiver 13 to make the UE establish a connection with the secondary BS according to the BS selection message. Then, the processor 15 transmits the BS selection message to the AMF via the connection port 13 to make the AMF select a second SMF from the SMFs according to the BS selection message, and to further make the second SMF select a second UPF from the UPFs for establishing a second PDU session with the UE via the secondary BS.

In one embodiment, the processor 15 transmits the BS selection message to the UE and the AMF at the same time.

In one embodiment, the neighbor BS parameter includes a cell identity of each of the neighbor BSs. In addition, in one embodiment, the BS selection message includes a cell identity of the secondary BS.

In one embodiment, the UE builds a RAN with the secondary BS according to the BS selection message.

In one embodiment, the UE information includes at least one of a current state, time information and position information of the UE.

In one embodiment, the AMF, the SMFs and the UPFs are respectively executed by one of an entity and a VM.

A third embodiment of the present invention describes a data transmission method, and a flowchart diagram thereof is as shown in FIG. 6. The data transmission method is adapted for use in a mobile communication system. The mobile communication system includes the BS, a core network and a plurality of neighbor BSs. The core network has an AMF, a plurality of SMFs and a plurality of UPFs. The BS includes a transceiver, a connection port and a processor. The connection port is configured to connected to the core network. The data transmission method is executed by the processor and the steps thereof are described as follows.

Step S601 is executed to receive a registration request message from a UE. The registration request message includes an ultra-reliable transmission parameter and a neighbor BS parameter. Step S603 is executed to transmits a transmission parameter message to the AMF. The transmission parameter message includes the ultra-reliable transmission parameter to make the AMF select a first SMF from the SMFs based on the ultra-reliable transmission parameter, and to further make the first SMF select a first UPF from the UPFs to establish a first protocol data unit (PDU) session with the UE via the BS.

Step S605 is executed to select a secondary BS from the neighbor BSs based on the ultra-reliable transmission parameter. Thereafter, step S607 is executed to transmit UE information to the secondary BS over a communication interface. Step S609 is executed to transmit a BS selection message to the UE. The UE establishes a connection with the secondary BS according to the BS selection message. Step S611 is executed to transmit the BS selection message to the AMF. The AMF selects a second SMF from the SMFs according to the BS selection message, and the second SMF selects a second UPF from the UPFs to establish a second PDU session with the UE via the secondary BS.

In one embodiment, step S609 and step S611 are executed at the same time.

In one embodiment, the neighbor BS parameter includes a cell identity of each of the neighbor BSs. In addition, in one embodiment, the BS selection message includes the cell identity of the secondary BS.

In one embodiment, the UE builds a RAN with the secondary BS according to the BS selection message.

In one embodiment, the UE information comprises at least one of a current state, time information and position information of the UE.

In one embodiment, the AMF, the SMFs and the UPFs are respectively executed by one of an entity and a VM.

In addition to the aforesaid steps, the data transmission method of the present invention can also execute all the operations described in the aforesaid embodiments and have all the corresponding functions, and how this embodiment executes these operations and has these functions based on the aforesaid embodiments shall be readily appreciated by those of ordinary skill in the art, and thus will not be further described herein.

According to the above descriptions, the data transmission method of the present invention is able to make the BS select a secondary BS based on the ultra-reliable transmission parameter of the UE, and provide the UE and the core network with information about the secondary BS so that the core network will select a SMF and a UPF for establishing a PDU session with the UE via the secondary BS when the UE is connecting to the BS. Besides, the BS can transmit transmission data and transmission parameters, with respect to the UE, to the secondary BS. Accordingly, the present invention can achieve objectives of reducing the number of established PDU sessions between the core network and the UE during establishing dual connectivity, avoiding waste of network resources, and reducing data transmission latency of establishing dual connectivity.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station (BS) for a mobile communication system, the mobile communication system comprising the BS, a core network and a plurality of neighbor BSs, the core network having an access and mobility management function (AMF), a plurality of session management functions (SMFs) and a plurality of user plane functions (UPFs), the BS comprising:
a transceiver;
a connection port, being configured to connect to the core network; and
a processor electrically connected to the transceiver and the connection port, being configured to execute the following operations:
receiving a registration request message from a user equipment (UE) via the transceiver, the registration request message comprising an ultra-reliable transmission parameter and a neighbor BS parameter;
transmitting a transmission parameter message comprising the ultra-reliable transmission parameter to the AMF via the connection port to make the AMF select a first SMF from the SMFs based on the ultra-reliable transmission parameter, and to further make the first SMF select a first UPF from the UPFs for establishing a first protocol data unit (PDU) session with the UE via the BS;
selecting a secondary BS from the neighbor BSs based on the ultra-reliable transmission parameter, and transmitting UE information to the secondary BS over a communication interface via the connection port;
transmitting a BS selection message to the UE via the transceiver to make the UE establish a connection with the secondary BS according to the BS selection message; and
transmitting the BS selection message to the AMF via the connection port to make the AMF select a second SMF from the SMFs according to the BS selection message, and to further make the second SMF select a second UPF from the UPFs for establishing a second PDU session with the UE via the secondary BS.

2. The BS of claim 1, wherein the processor transmits the BS selection message to the UE and the AMF at the same time.

3. The BS of claim 1, wherein the neighbor BS parameter comprises a cell identity of each of the neighbor BSs.

4. The BS of claim 1, wherein the BS selection message comprises a cell identity of the secondary BS.

5. The BS of claim 1, wherein the UE builds a radio access network (RAN) with the secondary BS according to the BS selection message.

6. The BS of claim 1, wherein the UE information comprises at least one of a current state, time information and position information of the UE.

7. The BS of claim 1, wherein the AMF, the SMFs and the UPFs are respectively executed by one of an entity and a virtual machine (VM).

8. A data transmission method of a base station (BS) for a mobile communication system, the mobile communication system comprising the BS, a core network and a plurality of neighbor BSs, the core network having an access and mobility management function (AMF), a plurality of session management functions (SMFs) and a plurality of user plane functions (UPFs), the BS comprising a transceiver, a connection port and a processor, the connection port being configured to connected to the core network, and the processor being electrically connected to the transceiver and the connection port, the data transmission method being executed by the processor and comprising:
receiving a registration request message from a user equipment (UE), the registration request message comprising an ultra-reliable transmission parameter and a neighbor BS parameter;
transmitting a transmission parameter message to the AMF, the transmission parameter message comprising the ultra-reliable transmission parameter to make the AMF select a first SMF from the SMFs based on the ultra-reliable transmission parameter, and to further make the first SMF select a first UPF from the UPFs to establish a first protocol data unit (PDU) session with the UE via the BS;
selecting a secondary BS from the neighbor BSs based on the ultra-reliable transmission parameter and transmitting UE information to the secondary BS over a communication interface;
transmitting a BS selection message to the UE to make the UE establish a connection with the secondary BS according to the BS selection message; and
transmitting the BS selection message to the AMF to make the AMF select a second SMF from the SMFs according to the BS selection message, and to further make the second SMF select a second UPF from the UPFs to establish a second PDU session with the UE via the secondary BS.

9. The data transmission method of claim 8, further comprising:
transmitting the BS selection message to the UE and the AMF at the same time.

10. The data transmission method of claim 8, wherein the neighbor BS parameter comprises a cell identity of each of the neighbor BSs.

11. The data transmission method of claim 8, wherein the BS selection message comprises a cell identity of the secondary BS.

12. The data transmission method of claim 8, wherein the UE builds a radio access network (RAN) with the secondary BS according to the BS selection message.

13. The data transmission method of claim 8, wherein the UE information comprises at least one of a current state, time information and position information of the UE.

14. The data transmission method of claim 8, wherein the AMF, the SMFs and the UPFs are respectively executed by one of an entity and a virtual machine (VM).
